(19) United States
(12) Patent Application Publication
(10) Pub. No.: US 2026/0070685 A1
(43) Pub. Date: Mar. 12, 2026

(54) VERTICAL TAKE-OFF AND LANDING VEHICLE

(71) Applicant: ideaForge Technology Limited, Navi Mumbai (IN)

(72) Inventors: Amey DAMJEE, Navi Mumbai (IN); Santosh MORE, Navi Mumbai (IN)

(21) Appl. No.: 19/323,215

(22) Filed: Sep. 9, 2025

(30) Foreign Application Priority Data
Sep. 12, 2024 (IN) 202421069103

(51) Int. Cl. B64U 10/20; B64U 20/70; B64U 20/87; B64U 30/14; B64U 30/29; B64U 50/30; B64U 60/50

(52) U.S. Cl. CPC B64U 10/20; B64U 20/70; B64U 20/87; B64U 30/14; B64U 30/29; B64U 50/30; B64U 60/50

(57) ABSTRACT

A vertical take-off and landing vehicle (100) includes a hollow fuselage (102) accommodating a power source (112-1,112-2); a fixed wing (106) is perpendicularly configured on the hollow fuselage (102) which accommodates avionics; a payload (110) detachably fixed to a mounting holder (108) of the fixed wing (106) through a vertical cavity (104) of the hollow fuselage (102). The fixed-wing (106) configured on the hollow fuselage (102) enables electrical communication from the power source (112-1,112-2) to the avionics for lifting and vertical landing of the payload (110) by the vehicle (100). An unmanned aerial vehicle (UAV) (200) includes a fuselage (202) having a tail rotor (204) inclinedly positioned where a rotational axis of the tail rotor (204) is positioned at a first predefined angle (X) relative to a horizontal axis of the fuselage (202) for providing axial thrust to facilitate horizontal movement of the UAV (200) and aerodynamics with reduced drag.

### TECHNICAL FIELD

The present disclosure relates generally to the field of vertical take-off and landing aerial vehicles. In particular, it pertains to an improved vertical take-off and landing (VTOL) aerial vehicle that is capable of enabling direct electrical connection between a power source and avionics system for more efficient payload handling with reduced aerodynamic drag.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Unmanned aerial vehicles (UAVs) have seen significant advancements in recent years, with a growing emphasis on development of hybrid quadrotor technology which combines both quadrotor and fixed-wing aerial vehicles to address the limitations typically encountered in traditional VTOL UAVs. Quadrotors being known for their ability to take off and land vertically, make them highly effective for operations in confined spaces or areas without dedicated runways. Fixed-wing aerial vehicles being known for their superior speed, range, and energy efficiency, make them highly effective for operations during sustained cruise flight.

Hybrid fixed-wing VTOL UAV featuring a combination of rotor-blade arms and fixed wings within a single aerial vehicle, which allows said VTOL UAV to take off and land vertically like a quadrotor while transitioning to a more efficient horizontal flight like a fixed-wing airplane.

Despite the above-stated advantages, there are several challenges associated with the design of above said hybrid fixed-wing VTOL UAV, including inefficient payload integration, limited modularity, and increased aerodynamic drag during horizontal flight, which restricts operational flexibility, and reducing the overall flight performance due to complex integration of both vertical and horizontal flight mechanisms.

Therefore, there exists a need in the state of art for an improved and more efficient hybrid VTOL UAV with an improved design to mitigate the above-mentioned challenges associated with known hybrid VTOL UAV by overcoming reduced drag, improving horizontal thrust efficiency, efficient payload handling, enhancing aerodynamic performance, and greater modularity for diverse mission requirements.

### OBJECTS OF THE INVENTION

A general object of the present disclosure is to mitigate challenges associated with known vertical take-off and landing aerial vehicles by providing an efficient, cost-effective, and improved vertical take-off and landing (VTOL) aerial vehicle that is capable of enabling direct electrical connection between a power source and avionics system for more efficient payload handling.

An object of the present disclosure is to enable easy and secure attachment or detachment of a fixed wing over a fuselage of the VTOL.

An object of the present disclosure is to provide a VTOL with a power source packed within the fixed wing.

An object of the present disclosure is to provide a VTOL with avionics systems packed within the fuselage.

An object of the present disclosure is to provide a VTOL with an inclined tail rotor to provide axial thrust and facilitate horizontal movement with reduced drag.

These and other objects of the present invention will become readily apparent from the following detailed description taken in conjunction with the accompanying drawings.

### SUMMARY

Aspects of the present disclosure pertain to vertical take-off and landing aerial vehicles. In particular, the aspects of the present invention relate to an improved vertical take-off and landing (VTOL) aerial vehicle that is capable of enabling direct electrical connection between a power source and avionics system for more efficient payload handling with reduced aerodynamic drag.

According to an aspect, the proposed vertical take-off and landing (VTOL) aerial vehicle includes a hollow fuselage having a vertical cavity at a medial portion. The hollow fuselage accommodates a power source there within. The proposed VTOL includes a fixed wing. The fixed wing is perpendicularly configured on the hollow fuselage. The fixed wing includes a mounting holder seated within the vertical cavity of the hollow fuselage. The fixed wing accommodates avionics.

The proposed VTOL includes a payload detachably fixed to the mounting holder through the vertical cavity and a fixed-wing configured on the hollow fuselage to enable electrical communication from the power source to the avionics for lifting and vertical landing of the payload by the vehicle.

In an embodiment, the power source may be a battery pack.

In an embodiment, the payload may be a gimbal having image acquisition units.

In an embodiment, the aerial vehicle may include a first rotor configured on a tail portion of the hollow fuselage to enable horizontal movement of the vehicle.

In an embodiment, the avionics may be selected from a flight controller, a global positioning module (GPS) module, an inertial measurement unit (IMU), an airspeed sensor, an electronic speed controller (ESC), a telemetry module, and a radio communication system.

In an embodiment, the fixed wing may be selected from a single wing, a left-wing and a right-wing coupled to one another, and a left wing and a right-wing coupled on sides of a medial wing.

In an embodiment, the vehicle may include a connector pin electrically connected to the hollow fuselage. The connector pin may be configured at the medial of the fixed wing for enabling avionics within the fixed wing to be in communication with the hollow fuselage and the payload.

In an embodiment, the aerial vehicle may include rotor arms perpendicularly fixed below the fixed wing on both sides of the hollow fuselage respectively.

In an embodiment, each of the pair of rotor arms may include second rotors inversely configured below each rotor arm for enabling vertical take-off of the vehicle.

In an embodiment, the aerial vehicle may include two landing legs attached beneath a front end and a back end of the hollow fuselage.

In an embodiment, the hollow fuselage may include a top portion having a groove to receive the fixed-wing and a bottom portion accommodating two landing legs for supporting the vehicle over a surface. The vertical cavity of the hollow fuselage may be located between the bottom portion and the top portion at the medial portion of the hollow fuselage. The hollow fuselage may accommodate the payload.

The hollow fuselage may include a nose portion configured at front end of the hollow fuselage enabling the vehicle to cut through air during horizontal movement. The hollow fuselage may include a tail portion having a first rotor configured at the back end of the hollow fuselage to facilitate zero dynamics with reduced drag. The top portion, the bottom portion, the nose portion, and the tail portion may define a space to accommodate the power source of the vehicle.

According to an aspect, an unmanned aerial vehicle (UAV) includes a fuselage including a tail rotor configured on a tail portion of the fuselage to facilitate aerodynamics with a reduced drag. The inclination of the tail rotor with a rotational axis positioned at a first predefined angle relative to a horizontal axis of the fuselage. The inclination of the tail rotor provides axial thrust to facilitate horizontal movement of the UAV with a reduced drag.

In an embodiment, the UAV may include a fixed wing perpendicularly configured on the fuselage. The fixed wing may include a pair of rotor arms. Each rotor arm may include two fixed wing rotors configured below the fixed wing for providing a vertical thrust to the UAV.

In an embodiment, the UAV may include a controller in communication with the tail rotor and the two fixed wing rotors to control their operation.

In an embodiment, the first predefined angle may be between 0 degrees and 10 degrees.

In an embodiment, the UAV may include a tapered intermediate component having a reducing thickness in vertical upward direction at a taper angle equal to the first predefined angle. The tail rotor fixed to the opposite surface of the intermediate component may make a second predefined angle with the horizontal axis of the fuselage.

In an embodiment, the inclined tail rotor may be rigidly fixed or rotatability fixed at the first predefined angle.

In an embodiment, the second predefined angle may be of a range between 0 degrees and greater than 90 degrees.

According to an aspect, a vertical take-off and landing (VTOL) includes a fixed-wing module and a fuselage module. The fixed-wing module includes avionics systems. The fuselage module includes battery packs. The fixed-wing module is configured to be detachably fixed on the fuselage module. The avionics systems receives electricity from the battery packs when the fixed wing module is fixed on the fuselage module.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A illustrates an exemplary perspective view of a vertical take-off and landing vehicle, in accordance with embodiments of the present disclosure.

FIG. 1B illustrates a side view of the proposed vertical take-off and landing vehicle, in accordance with an embodiment of the present disclosure.

FIG. 2 illustrates an exploded view of a fixed wing of the proposed vertical take-off and landing vehicle, in accordance with an embodiment of the present disclosure.

FIG. 3 illustrates an exploded view of the fixed wing assembled on a pair of rotor arms of the proposed vertical take-off and landing vehicle, in accordance with an embodiment of the present disclosure.

FIG. 4 illustrates an exploded view of a hollow fuselage with a payload of the proposed vertical take-off and landing vehicle, in accordance with an embodiment of the present disclosure.

FIG. 5A illustrates an exemplary perspective view of a vertical take-off and landing vehicle with an inclined tail rotor, in accordance with embodiments of the present disclosure.

FIG. 5B illustrates a magnified view of the inclined tail rotor on a fuselage of the proposed vehicle, in accordance with embodiments of the present disclosure.

FIG. 6 illustrates a side view of the proposed vertical take-off and landing vehicle (VTOL), in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments of the present disclosure relates to an improved vertical take-off and landing (VTOL) aerial vehicle that is capable of enabling direct electrical connection between a power source and avionics system for more efficient payload handling with reduced aerodynamic drag and weight.

According to an aspect, the disclosed VTOL vehicle includes a hollow fuselage that accommodates a power source and a fixed wing that is perpendicularly configured on the hollow fuselage. The VTOL includes a payload detachably fixed to a mounting holder of the fixed wing through a vertical cavity of the hollow fuselage. The fixed-wing is configured on the hollow fuselage enables electrical communication from the power source to the one or more avionics for lifting and vertical landing of the payload by the VTOL.

According to an aspect, an unmanned aerial vehicle (UAV) includes a fuselage having a tail rotor that is inclinedly positioned at a tail portion of the UAV such that a rotational axis of the tail rotor is positioned at a first predefined angle relative to a horizontal axis of the fuselage for providing axial thrust to facilitate horizontal movement of the UAV and aerodynamics with reduced drag.

According to an aspect, a vertical take-off and landing (VTOL) includes a fixed-wing module that includes one or more avionics systems and a fuselage module that includes one or more battery packs. The fixed-wing module may be configured to be detachably fixed on the fuselage module such that, when fixed, the one or more avionics systems receives electricity from the one or more battery packs.

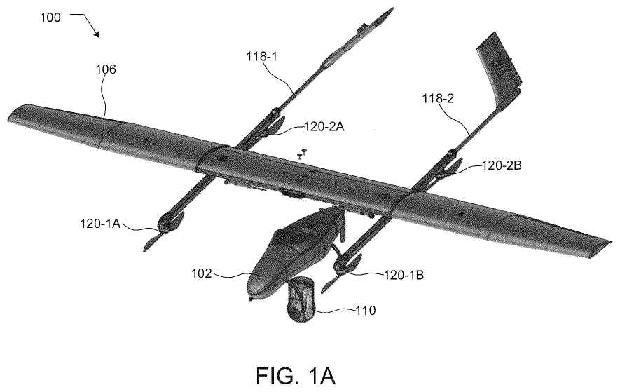

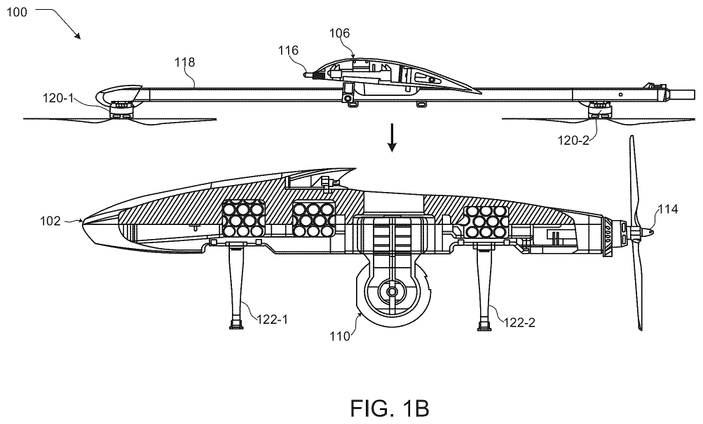

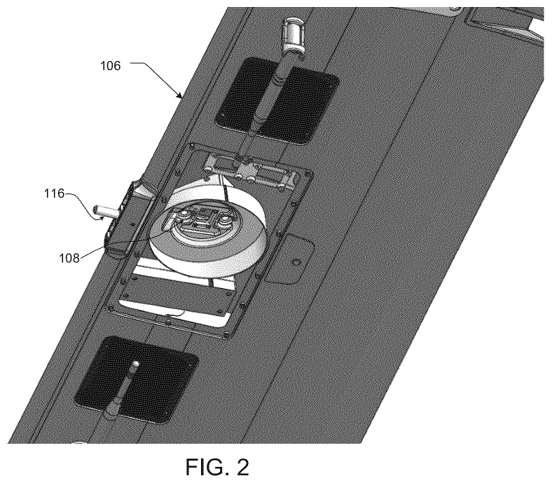

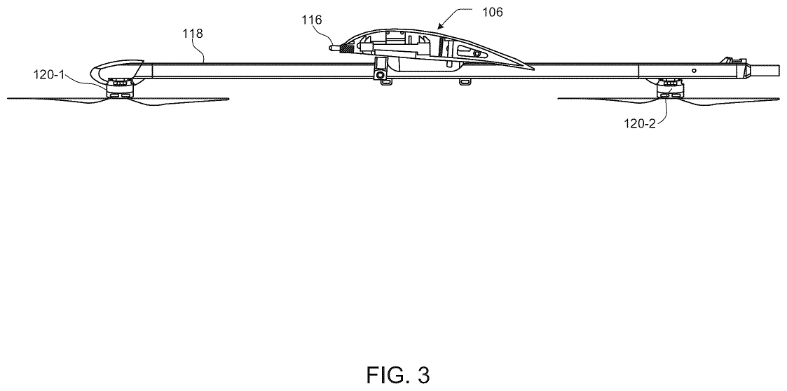

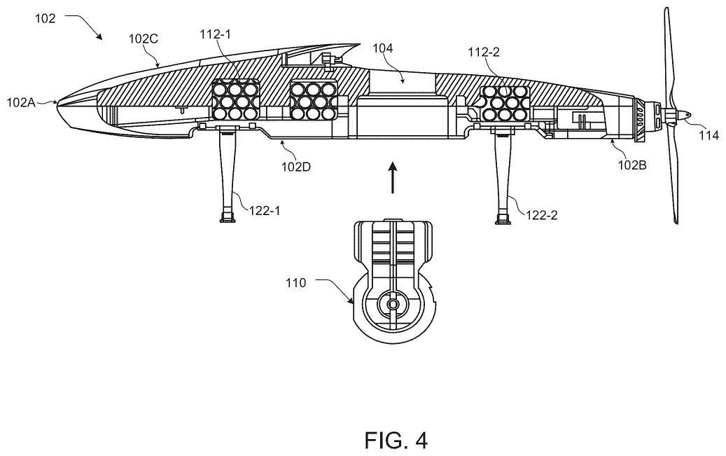

Referring to FIG. 1A to 4, describes a vertical take-off and landing vehicle (hereinafter referred as “vehicle 100”) includes a hollow fuselage 102, a fixed-wing 106, and a payload 110 as shown in FIG. 1A. The hollow fuselage 102 has a vertical cavity 104 at a medial portion. The fixed wing 106 has a mounting holder 108, and includes one or more avionics. The fixed wing 106 is perpendicularly configured on the hollow fuselage 102 such that the mounting holder 108 is seated within the vertical cavity 104 of the hollow fuselage 102. The fixed wing 106 can be a single wing, or a left-wing and a right-wing coupled to one another, or a left wing and a right-wing coupled on the sides of a medial wing. The payload 110 is removably fixed to the mounting holder 108 through the vertical cavity 104. The payload is air-lifted to be transported by the vehicle 100. The payload 110 can be a gimbal having one or more image acquisition units including but not limited to daylight image sensor, thermal image sensor, LIDAR, RADAR as shown in FIG. 4. In one embodiment, the payload 110 can be a gimbal carrying deliverable payloads.

In an embodiment, the fixed wing 106 can be a three-part wing with a mid wing and two side wings connected to each other with a longitudinal spar as shown in FIG. 1A. The longitudinal spar runs along the length of the fixed wing 106, providing structural integrity and strength. The fixed wing 106 can accommodate all avionics of the vehicle 100 which can include an autopilot system and one or more electrical power distribution components, which supply power to various components of the vehicle 100 such as a propulsion system and the payload 110. The mounting holder 108 can facilitate the payload 110 to be in communication with a main avionic system within the fixed wing 106 besides rigidly holding the payload 110. The mounting holder 108 can have apertures through which fastening elements such as screws may be inserted from a top surface of the fixed wing 106 to a top surface of the payload 110 such that the payload 110 be securely attached to the mounting holder 108 of the fixed wing 106 through the vertical cavity 104 within the hollow fuselage 102.

In an embodiment, the hollow fuselage 102 can include a nose portion 102A, a tail portion 102B, a top portion 102C, and a bottom portion 102D. The nose portion 102A can be configured at one end of the hollow fuselage 102 to enable the vehicle 100 to cut through the air during horizontal movement. The tail portion 102B can include at least one first rotor 114 assembled inclinedly at the other end of the hollow fuselage 102 for facilitating aerodynamics with a reduced drag of the vehicle 100.

The top portion 102C can include a groove that can be perpendicularly assembled to a fixed-wing 106 of the vehicle 100. The fixed wing 106 can be assembled in the groove on the top portion 102C of the hollow fuselage 102 through an inter-locking mechanism. The bottom portion 102D can accommodate a pair of landing legs 122-1,122-2 for supporting the vehicle 100 above the ground surface. The vertical cavity 104 can be between a bottom portion 102D to the top portion 102C, provided at the medial of the hollow fuselage 102 can be adapted to accommodate a payload 110 therewithin. The nose portion 102A, the tail portion 102B, the top portion 102C, and the bottom portion 102D, can define a hollow space to accommodate one or more power sources 112-1,112-2 for the vehicle 100.

In an embodiment, the hollow fuselage 102 can be configured for accommodating a power source 112-1,112-2 of the vehicle 100 within the hollow space available on both sides of the vertical cavity 104. The power source 112-1 can be positioned between the nose portion 102A of the hollow fuselage 102 and the vertical cavity 104 and the power source 112-2 can be positioned between the vertical cavity 104 and a tail portion 102B of the hollow fuselage 102. Further, the one or more power sources 112-1,112-2 can be one or more battery packs assembled on both sides or either side of the vertical cavity 104 at the medial in the hollow fuselage 102.

In an embodiment, the vehicle 100 can include at least one first rotor 114 positioned on a tail portion 102B of the hollow fuselage 102 to enable horizontal movement of the vehicle 100.

In an embodiment, the vehicle 100 can include a connector pin 116 electrically connected to the hollow fuselage 102. The connector pin 116 can be attached at the mid wing of the fixed wing 106, towards the nose portion 102A of the hollow fuselage 102 for enabling one or more avionics within the fixed wing 106 to be in communication with the hollow fuselage 102, and the payload 110. In an exemplary embodiment, in addition to the connector pin 116, a dowel pin is fixed on the mid wing of the fixed wing 106 for securing within the groove on the hollow fuselage 102. Further, fastening elements, such as screws can be used to secure the fixed wing 106 on the hollow fuselage 102.

In an embodiment, the vehicle 100 can include a pair of rotor arms 118-1,118-2 that are perpendicularly fixed below the fixed wing 106 on both sides of the hollow fuselage 102 respectively. The vehicle 100 can include one or more second rotors 120-1,120-2 assembled in an inverse configuration below each of the pair of rotor arms 118-1,118-2 for enabling vertical take-off of the vehicle 100.

In an exemplary embodiment, one second motor 120-1A, 120-1B can be attached to one end of the rotor arm 118-1 in a downward facing configuration and another second motor 120-2A, 120-2B can be attached to other end of the rotor arm 118-2 in a downward facing configuration. The pair of two second motors 120-1A, 120-1B, 120-2A, 120-2B can provide an aerodynamically efficient arrangement with no prop wash interference and very little intake interference which can significantly improve the vehicle 100's efficiency and lift capability.

In an exemplary embodiment, the pair of rotor arms 118-1,118-2 in their working position can provide an H-configuration to the at least two second rotors 120-1,120-2 that can be attached to the ends of each rotor arm of the pair of rotor arms 118-1,118-2. The pair of two second motors 120-1A, 120-1B, 120-2A, 120-2B can be inversely configured for being arranged in a H-configuration on the pair of rotor arms 118-1,118-2 as shown in FIG. 1A. The second motors 120-1A and 120-2A can be adapted for a clockwise rotation, the second motor 120-1B, 120-2B can be adapted for a counter-clockwise rotation for enabling vertical lift of the vehicle 100.

In an embodiment, the vehicle 100 can further includes at least two landing legs 122-1,122-2 attached beneath a front end and a back end of the hollow fuselage 102 such that one landing leg 122-1 towards the front end near to the nose portion 102A and other landing leg 122-2 towards the back end near to tail portion 102B of the hollow fuselage 102 for supporting the vehicle 100 on a surface. The landing legs 122-1,122-2 can be designed to balance weight of the vehicle 100 while taking-off and landing. Each landing leg 122-1,122-2 can include a right landing leg and a left landing leg that can be designed for quick assembly/disassembly with/from the vehicle 100 by means of landing leg mounts. The landing leg mount can be fixed beneath the hollow fuselage 102 and can incorporate a snap-fit locking mechanism to receive the left landing leg and the right landing leg.

Thus, the vertical take-off and landing vehicle (100) described herein offers an efficient design that integrates a hollow fuselage with a vertical cavity, a perpendicularly configured fixed wing, and a detachable payload system. This configuration not only enhances the vehicle's VTOL capabilities but also provides flexibility in payload handling and operational versatility. The inclusion of power sources, rotors for horizontal and vertical movement, avionics, and customizable wing configurations further underscores the vehicle's advanced engineering and adaptability for various applications.

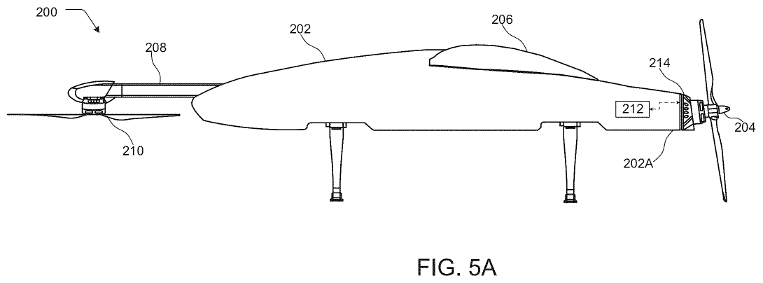

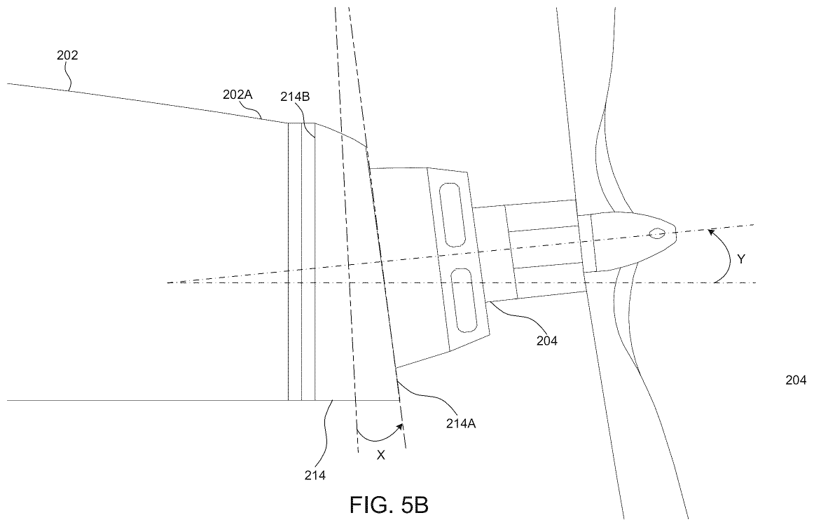

Referring to FIG. 5A to 5B, a vertical take-off and landing vehicle (herein after referred to as “vehicle 200”) can be designed to enhance aerodynamic efficiency with reduce drag during flight. The vehicle 200 can include a fuselage 202. The fuselage 202 can include an inclined tail rotor 204 configured on a tail portion 202A of the fuselage 202. The inclined tail rotor 204 can be specifically designed to facilitate aerodynamics with reducing drag, thereby improving the overall performance of the vehicle 200 during horizontal movement.

In an embodiment, the vehicle 200 can further includes a fixed wing 206 that can be perpendicularly configured on the fuselage 202. The fixed wing 206 can include a pair of rotor arms 208, each of which can be perpendicularly configured with the fixed wing 206. Each rotor arm 208 can include at least two rotors 210, which can be strategically positioned to provide the necessary lift and thrust for vertical take-off and landing operations.

In an embodiment, the inclination of the inclined tail rotor 204 can be characterised such that a vertical axis of the inclined tail rotor 204 can be positioned at a first predefined angle X relative to the horizontal axis of the fuselage 202. The above inclination can be designed to provide axial thrust, which can facilitate horizontal movement of the vehicle 200 while minimizing the drag, optimizing the balance between thrust and aerodynamic efficiency. Further, the predefined angle X, can be configured for facilitating a thrust-dependent pitching-up effect such that when the vehicle 200 needs to climb upwards, increased thrust will also increase pitch angle, enabling the vehicle 200 to have a better climb rate. In an exemplary embodiment, the predefined angle X can be between a range of 0 degrees to 90 degrees.

In an embodiment, the vehicle 200 can include a controller 212 that can be in communication with both the inclined tail rotor 204 and the least two rotors 210 on each rotor arm 208. The controller 212 can be configured to actuate these rotors, ensuring coordinated operation for both vertical and horizontal movements of the vehicle 200.

In an embodiment, the vehicle 200 can include a tapered intermediate component 214 having a reducing thickness in vertical upward direction at a taper angle that is equal to the first predefined angle X. The tapered intermediate component 214 can have an inclined end 214A and a flat end 214B can be positioned between the inclined tail rotor 204 and a rear end of the fuselage 202 such that the inclined end 214A can be fixed to the inclined tail rotor 204 and the flat end 214B can be fixed to the fuselage 202. Further, the inclined tail rotor can be rigidly fixed or rotatability fixed at the first predefined angle (X).

In an implementation, the rear end of the fuselage 202 can have a vertical surface. In which case the first predefined angle X can be kept equal to the second predefined angle Y. In an embodiment, changing the intermediate component 214with another intermediate component 214 having a different first predefined angle X can result in changing the second predefined angle Y.

The inclination of the inclined end 214A can be characterized by a second predefined angle Y relative to the vertical axis of the intermediate component 214. The second predefined angle Y can range from 0 degrees to greater than 90 degrees, providing flexibility in the design to achieve the desired aerodynamic performance.

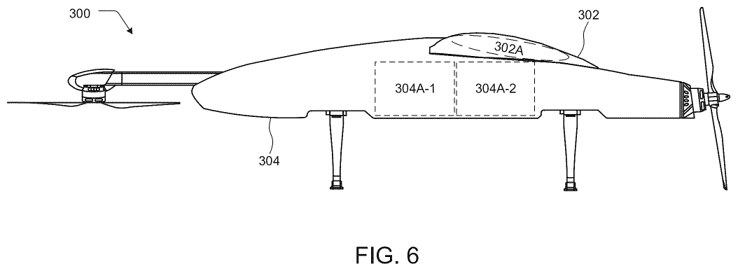

Referring to FIG. 6, a vertical take-off and landing vehicle (VTOL) (herein after referred to as “VTOL 300”) is described. The VTOL 300 includes a fixed-wing module 302 that includes one or more avionics systems 302A and a fuselage module 304 that includes one or more battery packs 304A-1,304A. The fixed-wing module 302 is configured to be detachably fixed on the fuselage module 304 such that the one or more avionics systems 302A receives electricity from at least one or both the one or more battery packs 304A-1,304-2 when the fixed wing module 304 is fixed on the fuselage module 304.

Thus, the vehicle 200 described herein offers an efficient design that significantly enhances aerodynamic performance with reduced drag. By incorporating an inclined tail rotor (204) positioned at a first predefined angle (X) relative to the fuselage (202), this innovative design is well-suited for a wide range of applications, providing reliable and efficient vertical take-off and landing performance combined with enhanced horizontal flight dynamics.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure is to provide an improved vertical take-off and landing (VTOL) aerial vehicle that is capable of enabling direct electrical connection between a power source and avionics system for more efficient payload handling.

The present disclosure provides a VTOL with reduced weight.

The present disclosure improves aerodynamics of the VTOL by reducing drag.

The present disclosure improves axial thrust of the VTOL and facilitates horizontal movement with reduced drag during flight.

We claim:

1. A vertical take-off and landing vehicle, the vehicle (100) comprising:
a hollow fuselage (102) having a vertical cavity (104) at a medial portion, accommodates a power source (112-1,112-2) therewithin;
a fixed wing (106) comprising a mounting holder (108), accommodates one or more avionics therewithin, the fixed wing (106) is perpendicularly configured on the hollow fuselage (102) such that the mounting holder (108) is seated within the vertical cavity (104) of the hollow fuselage (102); and
a payload (110) detachably fixed to the mounting holder (108) through the vertical cavity (104);
wherein the fixed-wing (106) configured on the hollow fuselage (102) enables electrical communication from the power source (112-1,112-2) to the one or more avionics for lifting and vertical landing of the payload (110) by the vehicle (100).

2. The vehicle (100) as claimed in claim 1, wherein the power source (112-1, 112-2) is a battery pack.

3. The vehicle (100) as claimed in claim 1, wherein the payload (110) is a gimbal having one or more image acquisition units.

4. The vehicle (100) as claimed in claim 1, wherein the vehicle (100) comprises at least one first rotor (114) configured on a tail portion (102B) of the hollow fuselage (102) to enable horizontal movement of the vehicle (100).

5. The vehicle (100) as claimed in claim 1, wherein the one or more avionics are selected from a group comprising a flight controller, a global positioning module (GPS) module, an inertial measurement unit (IMU), an airspeed sensor, an electronic speed controller (ESC), a telemetry module, and a radio communication system.

6. The vehicle (100) as claimed in claim 1, wherein the fixed wing (106) is selected from a group comprising a single wing, a left-wing and a right-wing coupled to one another, and a left wing and a right-wing coupled on sides of a medial wing.

7. The vehicle (100) as claimed in claim 6, wherein the vehicle (100) comprises a connector pin (116) electrically connected to the hollow fuselage (102), wherein the connector pin (116) is configured at the medial of the fixed wing (106) for enabling one or more avionics within the fixed wing (106) to be in communication with the hollow fuselage (102), and the payload (110).

8. The vehicle (100) as claimed in claim 1, wherein the vehicle (100) comprises a pair of rotor arms (118-1, 118-2) perpendicularly fixed below the fixed wing (106) on both sides of the hollow fuselage (102) respectively.

9. The vehicle (100) as claimed in claim 8, wherein each of the pair of rotor arms (118-1, 118-2) comprises one or more second rotors (120-1, 120-2) inversely configured below each of the pair of rotor arms (118-1, 118-2) for enabling vertical take-off of the vehicle (100).

10. The vehicle (100) as claimed in claim 1, wherein the vehicle (100) further includes at least two landing legs (122-1, 122-2) attached beneath a front end and a back end of the hollow fuselage (102).

11. The vehicle (100) as claimed in claim 1, wherein the hollow fuselage (102) comprises:
a top portion (102C) having a groove to receive the fixed-wing (106);
a bottom portion (102D) to accommodate at least two landing legs (122-1, 122-2) for supporting the vehicle (100) over a surface;
the vertical cavity (104) located between the bottom portion (102D) and the top portion (102C) at the medial portion of the hollow fuselage (102) that accommodates the payload (110) there within;
a nose portion (102A) configured at front end of the hollow fuselage (102) enabling the vehicle (100) to cut through air during horizontal movement; and
a tail portion (102B) comprising at least one first rotor (114) configured at the back end of the hollow fuselage (102) to facilitate zero dynamics with a reduced drag, wherein the top portion (102C), the bottom portion (102D), the nose portion (102A), and the tail portion (102B) define a space to accommodate the power source (112-1,112-2) of the vehicle (100).

12. An unmanned aerial vehicle (UAV) with an inclined tail rotor, the UAV (200) comprising:
a fuselage (202) comprising a tail rotor (204) configured on a tail portion (202A) of the fuselage (202) to facilitate aerodynamics with a reduced drag;
wherein the inclination of the tail rotor (204) is configured such that a rotational axis of the tail rotor (204) is positioned at a first predefined angle (X) relative to a horizontal axis of the fuselage (202) for providing axial thrust to facilitate horizontal movement of the UAV (200) with a reduced drag.

13. The UAV (200) as claimed in claim 12, wherein the UAV (200) comprises a fixed wing (206) perpendicularly configured on the fuselage (202), wherein the fixed wing (206) comprises a pair of rotor arms (208) each comprising at least two fixed wing rotors (210) configured below the fixed wing (206) for providing a vertical thrust to the aerial vehicle.

14. The UAV (200) as claimed in claim 12, wherein the UAV (200) comprises a controller (212) in communication with the tail rotor (204) and the least two fixed wing rotors (210) to control operation thereof.

15. The UAV (200) as claimed in claim 12, wherein the first predefined angle (X) is between 0 degrees and 10 degrees.

16. The UAV (200) as claimed in claim 12, wherein the UAV (200) comprises a tapered intermediate component (214) that has a reducing thickness in vertical upward direction at a taper angle that is equal to the first predefined angle (X) such that the when the tail rotor (204) is fixed to the opposite surface of the intermediate component (214), the tail rotor (204) makes a second predefined angle (Y) with the horizontal axis of the fuselage (202).

17. The UAV (200) as claimed in claim 16, wherein the inclined tail rotor is rigidly fixed or rotatability fixed at the first predefined angle (X).

18. The UAV (200) as claimed in claim 16, wherein the second predefined angle (Y) is between a range of 0 degrees and greater than 90 degrees.

19. A vertical take-off and landing (VTOL), the VTOL (300) comprising:
a fixed-wing module (302) comprising one or more avionics systems (302A); and
a fuselage module (304) comprising one or more battery packs (304A);
wherein the fixed-wing module (302) is configured to be detachably fixed on the fuselage module (304) such that, when fixed, the one or more avionics systems (302A) receives electricity from the one or more battery packs (304A).
